(19) United States
(12) Patent Application Publication
(10) Pub. No.: US 2009/0092436 A1
(43) Pub. Date: Apr. 9, 2009

(54) Anti-spill dauber wiper for a glue container

(76) Inventor: John Mercier, Cuddy, PA (US)

Correspondence Address: Floyd B. Carothers;CAROTHERS AND CAROTHERS, Suite 200, 445 Fort Pitt Blvd., Pittsburgh, PA, 15219, US

(21) Appl. No.: 11/906,811

(22) Filed: Oct. 4, 2007

(51) Int. Cl. B05C 11/10; B05C 21/00; B65D 25/02

(52) U.S. Cl. 401/122; 220/729; 401/130; 401/126

(57) ABSTRACT

An anti-spill dauber wiper for removable insertion into a threaded upwardly open cylindrical access neck of a glue container having a lid threadably received on the neck and a dauber for glue application secured to a bottom distal end of a dauber stem which depends downwardly from the lid for insertion in the glue contained in the container. The wiper includes a flexible cylindrical sleeve dimensioned to be inserted into an snugly received in sealed engagement with the container cylindrical access neck and the wiper is further provided with a flexible circular disk shaped closure membrane that spans the cylindrical interior of the sleeve. The disk shaped closure membrane is provided with slits therethrough which extend radially from the center of the closure member for thereby providing flexible pie shaped segments for permitting ingress and egress of the dauber to and from the container through the closure membrane with wiper application of the flexible segments. The wiper is further provided with a flexible circular rim seal secured to the upper end of the flexible sleeve which is dimensioned to be received over an upwardly exposed circular rim of the neck whereby the lid may be threadably received on the neck to close the container with the wiper received in the neck. The flexible sleeve of the wiper is further provided with at least two spaced outwardly protruding flexible annular ribs for engaging internal threaded contours of the neck to insure the sealed engagement with the access neck.

### BACKGROUND OF THE INVENTION

The present invention pertains generally to anti-spill closures, and more particularly to an anti-spill dauber wiper for removable insertion into a glue container.

A considerable amount of commercial and residential plumbing for water and waste pipes is accomplished with plastic pipes, such as PVC, ABS and CPVC. The plastic pipe joints are made with solvent type glues which are contained in sheet metal cans that have threaded upwardly open cylindrical access necks, a lid which is threadably received on the neck and a dauber for glue application, which is secured to the bottom distal end of a dauber stem which depends downwardly from the lid for insertion of the dauber into glue contained in the can or container. The glue is expensive and the threaded access neck of each container is a standard size for most all glue containers and is quite wide in diameter in order to permit easy ingress and egress of the dauber.

A problem occurs in that when the plumber is making glue applications, he or she is constantly moving from one location to another and the open glue cans are easily and readily knocked over thereby spilling the glue as the plumber moves about to make glue application to the plastic pipe joints. In addition, the glue dauber is generally over applied with glue which results in wasted messy dripping of the glue from the dauber or from the pipe parts.

It is a principal object of the present invention to provide an effective anti-spill dauber wiper for the glue container which minimizes these problems.

### SUMMARY OF THE INVENTION

The anti-spill dauber wiper of the present invention is comprised of a flexible cylindrical sleeve that is dimensioned to be inserted into and snugly received in sealed engagement within the container cylinder access neck. The wiper further includes a flexible circular disk shaped closure membrane which spans the cylindrical interior of the sleeve. This disk shaped closure membrane is provided with slits therethrough which extend radially from the center of the closure member for thereby providing flexible pie shaped segments for permitting ingress and egress of the dauber to and from the container through the closure membrane with wiper application of the flexible segments against the dauber as it is withdrawn from the container with its load of applied glue. The wiper further includes a flexible circular rim seal secured to the upper end of the sleeve. This rim seal is dimensioned to be received over the upwardly exposed circular rim of the container neck whereby the lid may be threadably received on the neck to close the container with the wiper received in the neck and with the lid in clamping engagement with the rim seal.

At least two spaced outwardly protruding flexible annular ribs are provided on the flexible sleeve for engaging internal threaded contours of the container neck to insure the sealed engagement with the access neck.

The result is that when the open can with the anti-spill dauber wiper of the present invention applied is knocked over, minimum or no spill occurs as the plumber is able to quickly upright the container before any of the expensive glue is lost through the slated membrane. In addition, the wiper application of the membrane segments removes excess glue from the dauber as the dauber is removed from the glue container.

In order to provide proper wiping capability of the glue dauber, the disk shaped closure membrane may include a central aperture which is smaller is diameter than the dauber.

The closure membrane may be in the same plane of the rim seal. However, in an alternative embodiment, the closure membrane may be positioned in the sleeve below the rim seal thereby providing a reservoir for excessive glue to flow back down into the container.

Generally, the dauber wiper is molded of a suitable flexible rubber or plastic as a single unit, which may be sold separately from the glue containers.

### BRIEF DESCRIPTION OF THE DRAWINGS

Other objects and advantages appear hereinafter in the following description and claims. The accompanying drawings show, for the purpose of exemplification, without limiting the scope of the present invention, certain practical embodiments of the present invention wherein:

FIG. 1 is a top view of one embodiment of the anti-spill dauber wiper of the present invention;

FIG. 2 is a view in side elevation of the anti-spill dauber wiper shown in FIG. 1;

FIG. 3 is a view in mid cross section of the anti-spill dauber wiper shown in FIG. 1 as seen along section line A-A;

FIG. 4 is a view in side elevation and shown in mid vertical cross section similar to that shown in FIG. 3, illustrating another embodiment of the anti-spill dauber wiper of the present invention;

FIG. 5 is a view in side elevation of a lid with an attached downwardly depending dauber for a typical glue container of the type shown in FIG. 6;

FIG. 6 is a view in side elevation of a typical sheet metal glue container, with the bottom of the container sectioned off, for containing glue or solvent therein and adapted to threadably receive the lid and dauber combination shown in FIG. 5;

FIG. 7 is a top view of the open sheet metal glue container shown in FIG. 6; and

FIG. 8 is a sectional view in side elevation of the sheet metal glue container illustrated in FIGS. 6 and 7 as seen along section line B-B of FIG. 7 illustrating the anti-spill dauber wiper of the present invention inserted in the neck thereof and shown in full.

### DETAILED DESCRIPTION OF THE PREFERRED EMBODIMENTS

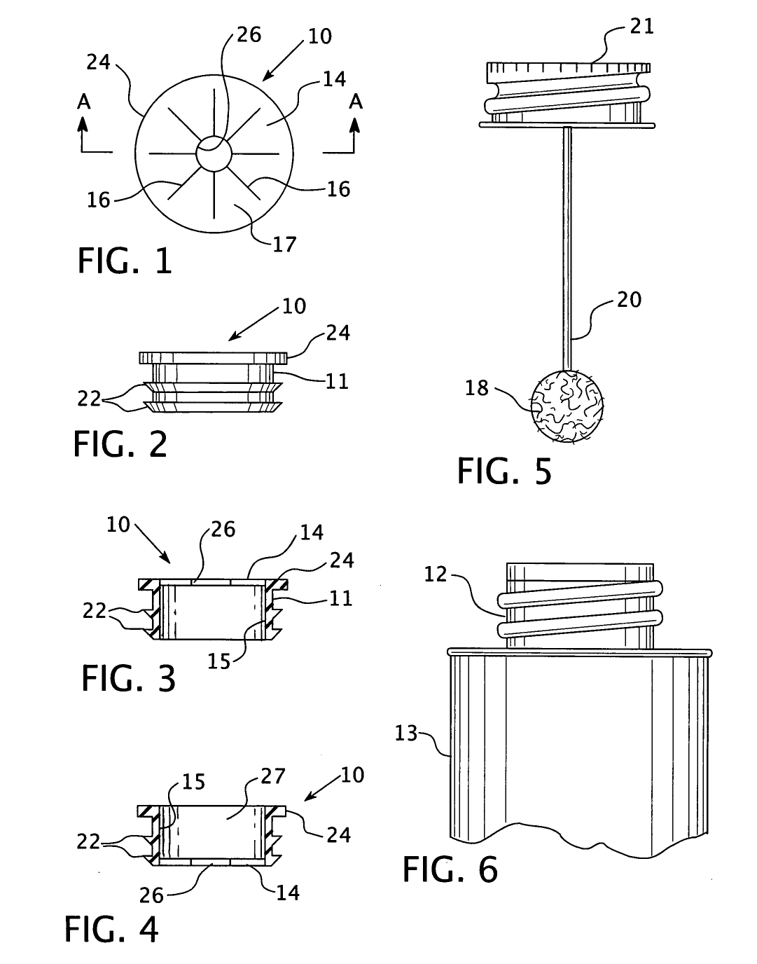

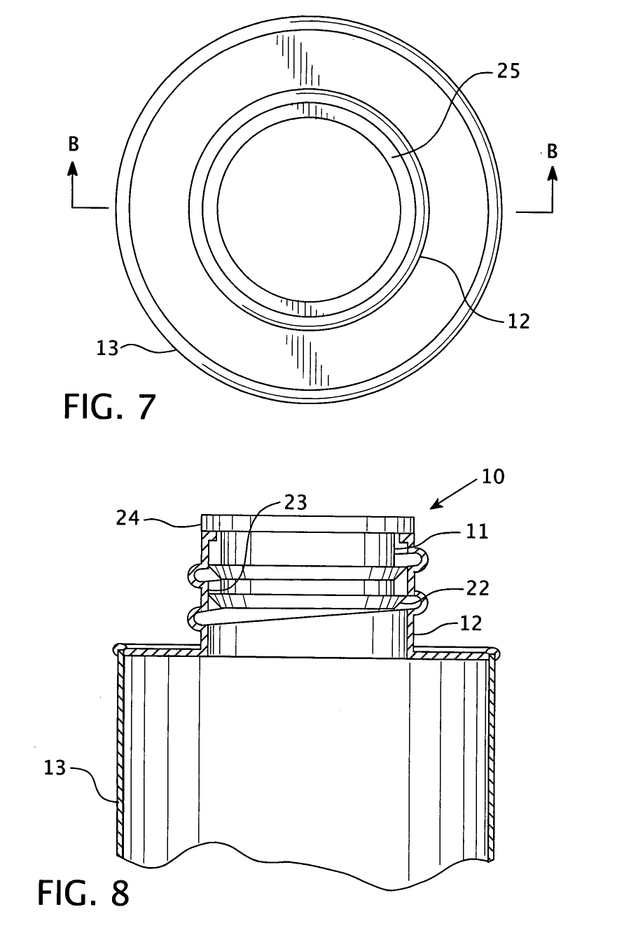

Referring to FIGS. 1 through 3 and 5 through 8, the anti-spill dauber wiper 10 of the present invention is a unitary structure molded of a suitable rubber or plastic and includes a flexible cylindrical sleeve 11 dimensioned to be inserted into and snugly received in sealed engagement within the cylindrical access neck 12 of sheet metal glue container 13.

The anti-spill dauber wiper 10 further includes a flexible circular disk shaped closure membrane 14 which spans the circular in cylindrical interior 15 of sleeve 11. Closure membrane 14 is provided with slits 16 which penetrate through closure membrane 14 and extend radially outward from the center of the closure membrane for thereby providing flexible pie shaped segments 17 permitting ingress and egress of dauber 18 through closure membrane 14 with wiper application of the flexible segments 17 applied thereto to regulate the glue application on dauber 18. Dauber 18 is secured to the bottom distal end of dauber stem 20, which in turn depends downwardly from metal lid 21 for insertion of the dauber 18 into the glue contained in container 13. Lid 21 threadably mates threaded access neck 12 of container 13 for closing the container.

The external cylindrical surface of flexible sleeve 11 is further provided with two spaced outwardly protruding flexible annular ribs 22 for engaging the internal thread contours 23 of neck 12 to insure the sealed engagement with the access neck 12.

The anti-spill dauber wiper 10 of the present invention further includes a flexible circular rim seal 24 which is secured to the upper end of sleeve 11 and is dimensioned to be received over upwardly exposed circular rim 25 of neck 12 whereby the lid 21 may be threadably received on neck 12 to close the container 13 with the wiper 10 received in neck 12.

Closure membrane 14 additionally includes a central aperture 26 which is smaller in diameter than that of dauber 18 to thereby regulate the wiping efficiency of wiper segments 17.

FIG. 4 illustrates another embodiment of the anti-spill dauber wiper 10 shown in FIGS. 1 through 3. In is embodiment the closure membrane 14 is provided below the rim seal 24, instead of in the same plane as specifically illustrated in FIG. 3, to therefore provide a glue reservoir 27 in anti-spill dauber wiper 10 so that excessive residue glue wiped from dauber 18, when being removed through wiper membrane 14, is contained and directed to flow back into container 13.

I claim:

1. An anti-spill dauber wiper for removable insertion into a threaded upwardly open cylindrical access neck of a glue container, the container including a lid threadably received on said neck and a dauber for glue application secured to a bottom distal end of a dauber stem which depends downwardly from said lid for insertion of said dauber into glue contained in said container, said wiper comprising:
a flexible cylindrical sleeve dimensioned to be inserted into and snugly received in sealed engagement within said container cylindrical access neck;
a flexible circular disk shaped closure membrane spanning the cylindrical interior of said sleeve, said disk shaped closure membrane having slits therethrough which extend radially from the center of said closure membrane for thereby providing flexible pie shaped segments for permitting ingress and egress of said dauber to and from said container through said closure membrane with wiper application of said flexible segments,
a flexible circular rim seal secured to an upper end of said sleeve and dimensioned to be received over an upwardly exposed circular rim of said neck whereby said lid may be threadably received on said neck to close said container with said wiper received in said neck, and
said flexible sleeve including at least one outwardly protruding flexible annular rib for engaging internal thread contours of said neck to insure the sealed engagement with said access neck.

2. The anti-spill dauber wiper of claim 1, said disk shaped closure membrane including a central aperture smaller in diameter than said dauber.

3. The anti-spill dauber wiper of claim 1, wherein said closure membrane is in the same plane as said rim seal.

4. The anti-spill dauber wiper of claim 1, wherein said closure membrane is positioned in said sleeve below said rim seal.

5. The anti-spill dauber wiper of claim 1, wherein said dauber wiper is a unitary molded item.

6. In combination, a glue container having an upwardly open threaded cylindrical neck having exposed internal thread contours and a lid threadably received on said neck for closing said container and a dauber secured to a bottom distal end of a dauber stem which depends downwardly from said lid for insertion of said dauber into said container; and
an anti-spill dauber wiper for removable insertion into said container neck and comprised of a flexible cylindrical sleeve dimensioned to be snugly inserted into and received in sealed engagement within said neck, and a flexible circular rim seal secured to an upper end of said sleeve and dimensioned to be received over an upwardly exposed circular rim of said neck whereby said lid may be threadably received on said neck to close said container with said wiper received in said neck, a flexible closure membrane spanning the interior of said neck, said closure membrane having slits therethrough which extend radially from the center of said closure membrane for thereby providing flexible pie shaped segments for permitting ingress and egress of said dauber to and from said container through said closure membrane with wiper application of said flexible segments, and at least one outwardly protruding flexible annular rib on said sleeve for engaging said internal thread contours of said neck to insure the sealed engagement with said access neck.

7. The combination of claim 6, wherein said disk shaped closure membrane includes a central aperture smaller in diameter than said dauber.

8. The combination of claim 6, wherein said closure membrane is in the same plane as said rim seal.

9. The combination of claim 6, wherein said closure membrane is positioned in said sleeve below said rim seal.

10. The combination of claim 6, wherein said dauber wiper is a unitary molded item.
